(19) United States
(12) Patent Application Publication
(10) Pub. No.: US 2025/0225531 A1
(43) Pub. Date: Jul. 10, 2025

(54) EXPANDABLE CONSTRUCTION METHOD FOR AN ARTIFICIAL INTELLIGENCE-BASED CUSTOMER SERVICE QUESTION AND ANSWER SYSTEM AND COMPUTER SYSTEM USING THE SAME

(71) Applicant: Charles Lap San CHAN, Taipei (TW)

(72) Inventor: Charles Lap San CHAN, Taipei (TW)

(21) Appl. No.: 18/990,375

(22) Filed: Dec. 20, 2024

(30) Foreign Application Priority Data
Jan. 4, 2024 (TW) 113100337

(51) Int. Cl. G06Q 30/015; G06N 20/00

(52) U.S. Cl. CPC G06Q 30/015; G06N 20/00

(57) ABSTRACT

The disclosure describes an expandable construction method for an artificial intelligence-based customer service question and answer system and a computer system using the same. In the expandable construction method for an artificial intelligence-based customer service question and answer, a customer service question and answer text as test material is inputted to test a question and answer artificial intelligence (AI) model. The question and answer AI model automatically outputs a question and answer report based on the customer service question and answer text. An expert artificial intelligence (AI) model automatically outputs an evaluation score based on the question and answer report. It is determined whether to input the question and answer report into the question and answer AI model to serve as training material based on the evaluation score.

### BACKGROUND OF THE INVENTION

This application claims priority for the TW patent application no. 113100337 filed on 4 Jan. 2024, the content of which is incorporated by reference in its entirely.

### FIELD OF THE INVENTION

The present invention relates to an expandable construction method for an artificial intelligence-based customer service question and answer system and a computer system using the same, particularly to an expandable construction method for an artificial intelligence-based customer service question and answer system and a computer system using the same that can automatically generate a question and answer report and determine whether to input the question and answer report into an artificial intelligence (AI) model to serve as training material.

### DESCRIPTION OF THE RELATED ART

With the rapid development of artificial intelligence (AI) technology, AI customer service systems have begun to be used in various industries to provide automated customer services. The Al customer service system is mainly based on natural language processing (NLP) and machine learning (ML) technology, which can simulate the dialogue mode of human customer service representatives and provide automatic responses to customer inquiries. However, once the traditional AI customer service system completes the initial training, the system's answer quality and accuracy will not further be improved if the system does not further be updated and adjusted.

In traditional models, the training of AI customer service systems usually depends on given data, which include manually labeled dialogue samples. This method is effective in establishing basic dialogue capabilities during the early stages, but it ignores customer needs and changes in conversational context over time. Once trained, these systems often lack the ability to continuously learn. Thus, the systems do not adapt to new customer inquiries or market demands that are changed.

In addition, traditional AI customer service systems perform poorly when dealing with unknown or rare questions. These systems are often unable to provide appropriate responses due to the lack of sufficient training data. This boundedness not only reduces customer satisfaction, but also limits the application potential of AI systems in more complex and changeable scenarios. In order to overcome these challenges, more advanced AI customer service systems need to be developed. These systems can endlessly learn and rapidly analyze data to continuously improve their dialogue processing capabilities and answer qualities.

### SUMMARY OF THE INVENTION

The primary objective of the present invention is to provide an expandable construction method for an artificial intelligence-based customer service question and answer system and a computer system using the same, which can automatically generate a question and answer report based on a customer service question and answer text.

Another objective of the present invention is to provide an expandable construction method for an artificial intelligence-based customer service question and answer system and a computer system using the same, which can automatically generate an evaluation score based on the question and answer report and determines whether to input the question and answer report into an artificial intelligence model to serve as training material.

In order to achieve the foregoing objectives, the present invention provides an expandable construction method for an artificial intelligence-based customer service question and answer system. The method includes:
Step (A): inputting a customer service question and answer text as test material to test a question and answer artificial intelligence (AI) model;
Step (B): by the question and answer AI model, outputting a question and answer report based on the customer service question and answer text;
Step (C): by an expert artificial intelligence (AI) model, outputting an evaluation score based on the question and answer report; and
Step (D): determining whether to input the question and answer report into the question and answer AI model to serve as training material based on the evaluation score.

The present invention also provides a computer system, which includes:
one or more processors; and
a memory coupled to the one or more processors and configured to store one or more programs, wherein when the one or more programs are performed by the one or more processors, the one or more processors performs an expandable construction method for an artificial intelligence-based customer service question and answer system, and the method comprises:
   Step (A): inputting a customer service question and answer text as test material to test a question and answer artificial intelligence (AI) model;
   Step (B): by the question and answer AI model, outputting a question and answer report based on the customer service question and answer text;
   Step (C): by an expert artificial intelligence (AI) model, outputting an evaluation score based on the question and answer report; and
   Step (D): determining whether to input the question and answer report into the question and answer AI model to serve as training material based on the evaluation score.

The features, advantages, or similar expressions mentioned in the specification do not mean that all the features and advantages that can be realized by the present invention should be in any single specific embodiment of the present invention. Rather, it should be understood that the expression of related features and advantages means that the specific features, advantages, or characteristics described in conjunction with specific embodiments are included in at least one specific embodiment of the present invention. Therefore, the discussion of features and advantages, and similar expressions in the specification is related to the same specific embodiment, but it is not necessary.

Below, the embodiments are described in detail in cooperation with the drawings to make easily understood the technical contents, characteristics and accomplishments of the present invention.

### BRIEF DESCRIPTION OF THE DRAWINGS

FIG. 1 is a flowchart of an expandable construction method for an artificial intelligence-based customer service question and answer system according to a preferred embodiment of the present invention; and

FIG. 2 is a block diagram illustrating an exemplary computer system/server suitable for implementing embodiments of the present invention.

### DETAILED DESCRIPTION OF THE INVENTION

In order to make the description of the present disclosure more detailed and complete, the following provides an illustrative description for the implementation aspects and specific embodiments of the present invention; but this is not the only way to implement or use specific embodiments of the present invention. The implementations cover the characteristics of specific embodiments and the steps and sequences of the method used to construct and operate these specific embodiments. However, other specific embodiments can also be used to achieve the same or equal functions and sequence of steps.

It should be noted that, unless otherwise specified, all functions described herein may be implemented in hardware or used as software instructions that enable a computer to perform predetermined operations, wherein the software instructions are implemented in a computer-readable storage media, such as a random-access memory (RAM), a hard disk drive, a flash memory, or other types of a computer-readable storage media known to those skilled in the art. In some embodiments, the predetermined operations of the computer are performed by a processor, such as a computer, or performed by program codes such as computer program codes or program codes of software or firmware. In some embodiments, the predetermined operations of the computer are performed by integrated circuits encoded to perform these functions. Furthermore, it should be understood that various operations described herein as being performed by a user may be performed manually by the user or may be automatically performed with or without instructions provided by the user.

In order to make the purpose, technical solutions and advantages of the embodiments of the present invention clearer, the technical solutions in the embodiments of the present invention will be clearly and completely described below in conjunction with the accompanying drawings in the embodiments of the present invention. Obviously, the described embodiments are parts of the embodiments of the present invention rather than all the embodiments. Based on the embodiments of the present invention, all other embodiments obtained by those of ordinary skill in the art without creative efforts are included within the scope of the present invention.

It should be noted that the terminals involved in the embodiments of the present invention may include, but are not limited to, mobile phones, personal digital assistants (PDAs), wireless handheld devices, wireless network devices, personal computers, portable computers, tablets computers, MP3 players, MP4 players, wearable devices (such as smart glasses, smart watches, smart bracelets, etc.), mobile phones, smart phones, landline smart phones, etc.

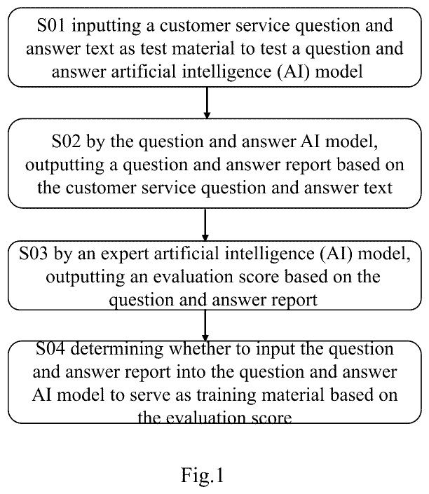

FIG. 1 is a flowchart of an expandable construction method for an artificial intelligence-based customer service question and answer system according to a preferred embodiment of the present invention. As illustrated in FIG. 1, the method includes the following steps.

In Step 101, a customer service question and answer text as test material is inputted to test a question and answer artificial intelligence (AI) model.

In Step 102, the question and answer AI model outputs a question and answer report based on the customer service question and answer text.

In Step 103, an expert artificial intelligence (AI) model outputs an evaluation score based on the question and answer report.

In Step 104, it is determined whether to input the question and answer report into the question and answer AI model to serve as training material based on the evaluation score.

It should be noted that the body that performs Steps 101˜104 can be an application installed in the local terminal, either a plug-in program or a functional unit such as software development kit (SDK) in the application installed in the local terminal, or a processing engine in a network-side server, the embodiment is not limited thereto.

It can be understood that the application can be an application program (e.g., a native App) installed in the terminal or a webpage program (e.g., a web App) of the browser on the terminal, the embodiment is not limited thereto.

In order to initially train the question and answer AI model that can performs customer service question and answer, it can be understood that one can firstly provide some data to the question and answer AI model to serve as training data for learning and training before Step S101. For example, the training data include the following items.
1. Past customer service dialogue records: The records, including actual questions and answers in past customer service interactions, can be obtained from the company's customer service database. The record's advantage is that real-world question and answer cases can be provided, which helps the model understand customer needs in specific fields.
2. Frequently Asked Questions (FAQs): These are standardized answers to frequently asked questions and are usually found on the company website. FAQs' advantage is that structured and precise information is provided, which is very helpful for AI models to understand common questions.
3. Customer service guides and internal training material: These include a company's policies, procedures, product information, etc. Their advantage is that it helps the AI model understand how the company operates and product/service details.
4. Social media and forum posts: These are like customer questions and comments on social media and online forums. The advantage is that various and more informal dialogue samples are provided, which helps understand the user's tone and word usage.

It should be understood that the training material of the present invention is not limited to the foregoing items.

After collecting the foregoing training data, the question and answer AI model in the customer service question and answer system of the present invention can perform the initial training process of a common AI model. The initial training process includes the following steps.
1. Data preprocessing: Clean the collected data, such as removing irrelevant information, correcting errors, standardizing formats, etc. Perform natural language processing steps such as word segmentation and part-of-speech tagging on the text.
2. Feature extraction: Extract useful features from the text, such as keywords, sentence structures, emotional tendencies, etc.
3. Choose an appropriate machine learning model: Choose an appropriate model according to requirements, such as decision tree, support vector machine (SVM), deep learning model, etc.
4. Training model: Use the preprocessed data training model, which may require multiple rounds of iterative training.
5. Evaluation and fine-tuning: Use the test set to evaluate the performance of the model and make adjustments and optimizations based on the results.
6. Practical application testing: Test the performance of the AI model in a real environment and further finely tune the AI model.

The foregoing process is the initial training process performed by the common AI model so it will not be reiterated.

In Step 101 of the present invention, a customer service question and answer text as test material is inputted to test a question and answer artificial intelligence (AI) model. One can select or create a set of customer service question and answer texts that represent typical customer inquiries and standard answers. For example, the text can be selected from existing customer service records. Alternatively, a simulated dialogue can be written by a professional. In other embodiments, customer service communication records in the public database can be also used as the customer service question and answer text to improve the applicability and flexibility of the question and answer AI model.

In order to help understanding, an exemplary customer service question and answer text is provided as follows, wherein the customer service staff is Mr. Chen and the customer who called is Mr. Zhang. The content of the customer service question and answer text is described as follows.
Mr. Chen: Hello, this is the customer service center. I am Mr. Chen. How can I help you?
Mr. Zhang: Hello, I am Mr. Zhang. There was a quality issue with a product that I recently ordered and I'm very unhappy about it. p
1 Mr. Chen: I'm sorry to hear that you encountered such a problem, Mr. Zhang. Could you please describe in detail what the specific problem is?
Mr. Zhang: The appearance of the product is completely different from the description on the website when I ordered it. I ordered a blue one, but I received a green one instead. Additionally, the size is much smaller. Your quality control is very problematic.
Mr. Chen: I understand. I'm very sorry for causing you such inconvenience. To solve this problem, we can arrange returns and exchanges for you. In addition, we will provide you with a discount coupon as an apology.
Mr. Zhang: That sounds good. I hope it works out this time.
Mr. Chen: Of course, Mr. Zhang. We will deal with this matter as soon as possible. Thank you for your understanding and patience.
Mr. Zhang: OK, thank you for your help.

In Step 102, the question and answer AI model outputs a question and answer report based on the customer service question and answer text. The question and answer AI model analyzes the test material, identifies the question and answer mode, and then generates a report describing the handling and the response strategy for each question and answer. For example, in an embodiment of the present invention, the question and answer AI model can output the question and answer report based on the customer service question and answer text and an item list.

The items included in the item list are used to standardize the format and content of the question and answer report. The items in the item list include the summary of customers' questions, manners to resolve questions, extracted keywords, ways to respond to customers in a comfortable manner, customers' emotional states and intensities, the noting items of reminding customers' service staffs, the primary intent of a customer's questions, or a combination of these, but the present invention is not limited thereto. It should be understood that the question and answer AI model is asked to output the question and answer report based on the item list, such that each question and answer report can include one or a combination of the items in the item list, which will help output an evaluation score corresponding to the question and answer report in subsequent steps.

In order to help understanding, an exemplary question and answer report is provided as follows. The question and answer report is outputted based on the customer service question and answer text provided above, and the specifications of the item list. The content of the question and answer report in this example is described as follows, but the present invention is not limited thereto.

### Summary of Customers' Questions:

The appearance and size of the product ordered by Mr. Zhang did not match the description on the website. The color (i.e., green) of the product received was inconsistent with the color (i.e., blue) of the product ordered, and the size of the product received was smaller than expected.

### Manners to Resolve Questions:

Provide returns and exchanges and provide Mr. Zhang with a discount coupon as an apology.

### Extracted Keywords:

Product quality
Product does not match description
Returns and exchanges
Discount coupons

### Ways to Respond to Customers in a Comfortable Manner:

“Mr. Zhang, we value your feedback and feel sorry for the product questions. We will handle the return and exchange for you immediately and provide discount coupons as our sincere apology. Your satisfaction is our greatest pursuit. Please rest assured. We will ensure that this question is properly resolved.”

### Customers' Emotional States and Intensities:

Emotional language: “very dissatisfied”
Emotional level: a (excited and passionate)

### Noting Items of Reminding Customers' Service Staffs:

Listen carefully to the questions described by customers and avoid interrupting or ignoring customer demands.
Express empathy and apology even if the question may not have been directly caused by customer services.
Provide clear solutions and ensure that customers understand and feel satisfied with them.
Maintain a professional attitude even when dealing with emotional clients.

### Primary Intent of Customer's Questions:

Mr. Zhang hopes not only to obtain solutions to product questions, but also to obtain serious treatment and respect by the enterprise. By providing return and exchange services and discount coupons, it can be shown that the company is aware of customer inconvenience and is willing to take responsibility.

In Step 103, an expert artificial intelligence (AI) model outputs an evaluation score based on the question and answer report. In the present invention, the expert AI model can further evaluate the question and answer report based on a given evaluation condition combination to output the evaluation score. The evaluation condition combination includes response speed, resolution efficiency, communication skills, customer satisfaction, compliance with procedures and policies, etc., but the present invention is not limited thereto. The evaluation condition combination is used as a reference for scoring.
Response speed: customer service personnel should respond to customer inquiries within a specific time interval.
Resolution efficiency: It evaluates the speed and efficiency of customer service personnel in solving questions.
Communication skills: It includes tone, word choice, listening ability, etc.
Customer Satisfaction: It is accessed according to surveys or direct feedback.
Compliance with procedures and policies: It evaluates whether customer service personnel are acting according to company procedures and policies.

In the present invention, the expert AI model can be based on external artificial intelligence models, such as Google Cloud Natural Language application programming interface (API), IBM Watson Assistant, OpenAI's GPT-series, Amazon Comprehend, or Microsoft Azure Cognitive Services, etc. In addition, the expert AI model of the present invention can also be based on models in offline self-built servers, such as Meta's Llama 2 and so on.

In order to help understanding, an exemplary evaluation condition combination is provided as follows, but the present invention is not limited thereto. The example described as follows provides the scoring rules for each condition and the judgment based on the scoring rules.

Each question is worth 20 points and the total score is 100 points.

### Response Speed

### Scoring Rules

20 points: Respond to customer inquiries within the specified time interval (e.g. 5 minutes).
15 points: Respond to customer inquiries within the specified time interval but need to remind customers to wait.
10 points: Respond to customer inquiries beyond the specified time interval.
Judgment based on the scoring rules: It is not possible to directly judge from the dialogue whether Mr. Chen's response speed meets the requirements within the specified time interval. However, based on the fluency of the dialogue, it is judged that he responded to customer inquiries within the specified time interval. Thus, 20 points can be awarded. Individual score: 20 points

### Resolution Efficiency

### Scoring Rules

20 points: Solve the question within a time interval that satisfies the customer (e.g. 5 minutes).
15 points: Solve the question within a time interval acceptable to the customer.
10 points: Solve the question beyond a time interval acceptable to the customer.
Judgment based on the scoring rules: Mr. Chen quickly proposed solutions (i.e., return and exchange services and discount coupons), which show efficient question-solving capabilities. According to the content of the dialogue, it was judged that Mr. Chen solved the question within a time interval that satisfied the customer.
Individual Score: 20 Points

### Communication Skills

Scoring rules
20 points: friendly and polite tone, clear and easy to understand words, and strong listening ability
15 points: friendly and polite tone, clear words, and average listening ability
10 points: unfriendly and impolite tone, unclear words, and poor listening ability
Judgment based on the scoring rules: Mr. Chen showed a friendly and polite attitude in the dialogue, used clear and understandable words, and demonstrated good listening skills.
Individual score: 20 points

### Customer Satisfaction

### Scoring Rules

20 points: The customer is satisfied with the customer service staff's service.
15 points: The customer is basically satisfied with the customer service staff's service.
10 points: The customer is dissatisfied with the customer service staff's service
Judgment based on the scoring rules: It can be seen from the dialogue that Mr. Zhang feels satisfied with the solution provided by Mr. Chen and expresses his gratitude for Mr. Chen's help.
Individual score: 20 points

### Compliance With Procedures and Policies

### Scoring Rules

20 points: fully complying with the company's procedures and policies
15 points: basically complying with the company's procedures and policies, but having a few omissions
10 points: failing to comply the company's procedures and policies
Judgement based on the scoring rules: In the dialogue, the customer service staff surnamed Chen seemed to only and partially comply with the company's procedures and policies. The customer service staff initiatively provides compensation measures. However, the measures must be approved by the supervisor before the compensation measures can be implemented. Therefore, 4 points were deducted to show strict compliance with company regulations.
Individual score: 16 points

### Overall Score: 96 Points (Meet the Standards)

In Step 104, it is determined whether to input the question and answer report into the question and answer AI model to serve as training material based on the evaluation score. Assume that the evaluation score has a range of 0-100 points. If it can reach the predetermined standard (e.g., 80 points or more), the question and answer report will be included in the training set of the question and answer AI model to further improve its performance. If it cannot reach the predetermined standard, the question and answer report will be discarded and excluded from the training set of the question and answer AI model. In other embodiments of the present invention, the question and answer report can be used to diagnose and improve the specific aspects of the question and answer AI model when the evaluation score is in a low range (e.g., 59 points or less). Alternatively, when the evaluation score is in a middle range (e.g., between 60 and 79), a part of data are used for training, but also requiring further the manual review by human experts. That is to say, different following actions can be respectively set for different scoring levels.

According to the explanation above, the present invention provides an expandable construction method for an artificial intelligence-based customer service question and answer system that can automatically generate a question and answer report based on a customer service question and answer text. The expandable construction method for an artificial intelligence-based customer service question and answer system of the present invention automatically generates an evaluation score evaluation score based on the question and answer report and determines whether to input the question and answer report into an artificial intelligence model to serve as training material. The expandable construction method for an artificial intelligence-based customer service question and answer system of the present invention can endlessly learn and rapidly analyze data to continuously improve the dialogue processing capabilities and answer qualities.

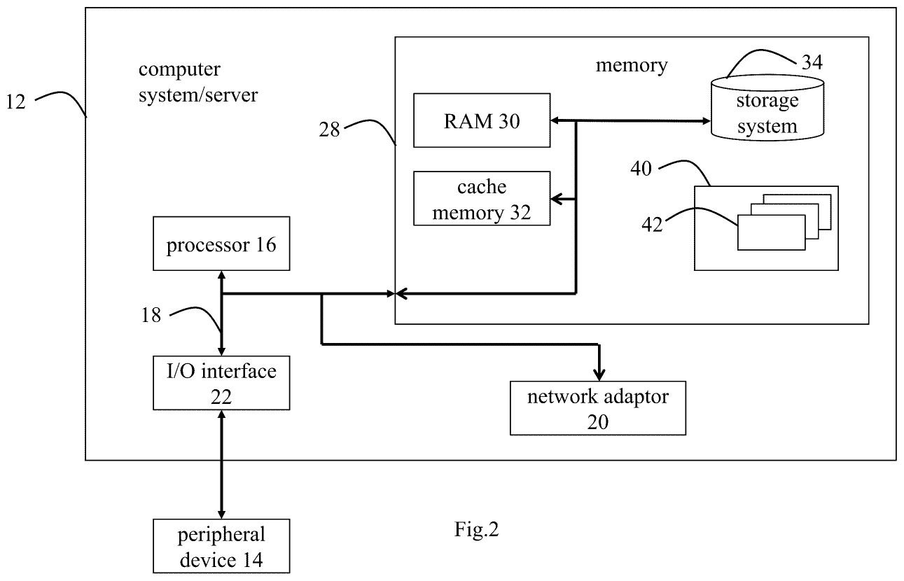

FIG. 2 is a block diagram illustrating an exemplary computer system/server suitable for implementing embodiments of the present invention. FIG. 2 shows an exemplary computer system/server 12 that should not impose any limitations on the functions and the application ranges of the embodiments of the present invention.

Bus 18 represents one or more of any of several kinds of bus structures, including a memory bus or a memory controller, a periphery bus, an accelerated graphics port, and a processor or a local area bus using any bus structure among a plurality of bus structures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The computer system/server 12 typically includes a variety of computer system readable mediums. These mediums may be any available medium accessible to the computer system/server 12, including volatile and non-volatile mediums, mobile and immobile mediums.

Memory 28 may include a computer system readable medium in the form of volatile memory, e.g., a random-access memory (RAM) 30 and/or a cache memory 32. The computer system/server 12 may further include other mobile/immobile, volatile/non-volatile computer system storage mediums. For example, storage system 34 may be used to read and write immobile and non-volatile magnetic media. Although not shown in FIG. 2, a disk driver that may read/write the mobile non-volatile disk (e.g., “floppy disk”), and an optical disk driver that reads/writes the mobile non-volatile optical disk (e.g., CD-ROM, DVD-ROM, or other optical medium). In these cases, each driver may be connected to the bus 18 through one or more data medium interfaces. The memory 28 may include at least one program product, which program product has a set (e.g., at least one) of program modules. These program modules are configured to perform the functions of various embodiments of the present invention.

Program/utility tool 40 having a set (at least one) of the program module 42 may be stored in, e.g., a memory 28. Such program module 42 includes, but not limited to, an operating system, one or more applications, other program modules, and program data; each or a certain combination of these examples might include implementation of the network environment. The program module 42 generally performs the functions and/or methods in the embodiments described in the present invention.

The computer system/server 12 may also communicate with one or more peripheral devices 14 (e.g., keyboard, pointing device, display, etc.), but also communicate with one or more devices enabling the user to interact with the computer system/server 12, and/or communicate with any device (e.g., network card, modem, etc.) enabling the computer system/server 12 to communicate with one or more other computing devices. This communication may be performed through an input/output (I/O) interface 22. Moreover, the computer system/server 12 may also communicate with one or more networks (e.g., local area network (LAN), wide area network (WAN) and/or public network, e.g., Internet) through a network adaptor 20. As shown in FIG. 2, the network adaptor 20 communicates with other module of the computer system/server 12 via the bus 18. It should be noted that although not shown in the figure, other hardware and/or software module may be used in conjunction with the computer system/server 12, including, but not limited to: microcode, device driver, redundant processing unit, external disk driving array, RAID system, disk driver, and data backup storage system, etc.

Processor 16 runs programs stored in the memory 28 to perform various functional applications and data processing, such as implementing the method in the embodiment shown in FIG. 1.

The present invention also discloses a computer-readable storage medium where a computer program is stored. When the program is run by the processor, the method in the embodiment shown in FIG. 1 will be implemented.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or apparatus, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage apparatus, a magnetic storage apparatus, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the several embodiments provided in this disclosure, it should be understood that the devices and methods disclosed can be implemented by other means. For example, the device embodiments described above are only schematic. For example, the division of the modules is only by logical function, and can be implemented in another way.

The modules described as separate parts may or may not be physically separate, and the parts displayed as modules may or may not be physical units, that is, may be located in one place, or may be distributed over multiple network units. Part or all of the modules can be selected according to the actual needs to achieve the purpose of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The foregoing integrated units implemented in the form of software function units may be stored in a computer readable storage medium. The foregoing software function units may be stored in a storage medium, and include several instructions to enable a computing device (which may be a personal computer, server, or network device, etc.) or processor to execute a part of steps of the method described in the embodiment of the present disclosure. The foregoing storage media include USB flash drives, mobile hard drives, read-only memories (ROMs), random access memories (RAMs), magnetic disks, optical disks, or other media that can store program codes.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. An expandable construction method for an artificial intelligence-based customer service question and answer system, comprising:
Step (A): inputting a customer service question and answer text as test material to test a question and answer artificial intelligence (AI) model;
Step (B): by the question and answer AI model, outputting a question and answer report based on the customer service question and answer text;
Step (C): by an expert artificial intelligence (AI) model, outputting an evaluation score based on the question and answer report; and
Step (D): determining whether to input the question and answer report into the question and answer AI model to serve as training material based on the evaluation score.

2. The expandable construction method for an artificial intelligence-based customer service question and answer system according to claim 1, wherein in Step (B), the question and answer AI model outputs the question and answer report based on the customer service question and answer text and an item list.

3. The expandable construction method for an artificial intelligence-based customer service question and answer system according to claim 2, wherein the item list includes a summary of customers' questions, manners to resolve questions, extracted keywords, ways to respond to customers in a comfortable manner, customers' emotional states and intensities, noting items of reminding customers' service staffs, a primary intent of a customer's questions, or a combination of these.

4. The expandable construction method for an artificial intelligence-based customer service question and answer system according to claim 1, wherein in Step (C), the expert AI model outputs the evaluation score based on the question and answer report and an evaluation condition combination.

5. The expandable construction method for an artificial intelligence-based customer service question and answer system according to claim 4, wherein the evaluation condition combination includes response speed, resolution efficiency, communication skills, customer satisfaction, compliance with procedures and policies, or a combination of these.

6. A computer system comprising:
one or more processors; and
a memory coupled to the one or more processors and configured to store one or more programs, wherein when the one or more programs are performed by the one or more processors, the one or more processors performs an expandable construction method for an artificial intelligence-based customer service question and answer system, and the method comprises:
Step (A): inputting a customer service question and answer text as test material to test a question and answer artificial intelligence (AI) model;
Step (B): by the question and answer AI model, outputting a question and answer report based on the customer service question and answer text;
Step (C): by an expert artificial intelligence (AI) model, outputting an evaluation score based on the question and answer report; and
Step (D): determining whether to input the question and answer report into the question and answer AI model to serve as training material based on the evaluation score.

7. The computer system according to claim 6, wherein in Step (B), the question and answer AI model outputs the question and answer report based on the customer service question and answer text and an item list.

8. The computer system according to claim 7, wherein the item list includes a summary of customers' questions, manners to resolve questions, extracted keywords, ways to respond to customers in a comfortable manner, customers' emotional states and intensities, noting items of reminding customers' service staffs, a primary intent of a customer's questions, or a combination of these.

9. The computer system according to claim 6, wherein in Step (C), the expert AI model outputs the evaluation score based on the question and answer report and an evaluation condition combination.

10. The computer system according to claim 9, wherein the evaluation condition combination includes response speed, resolution efficiency, communication skills, customer satisfaction, compliance with procedures and policies, or a combination of these.
